(19) United States
(12) Patent Application Publication
(10) Pub. No.: US 2019/0100639 A1
(43) Pub. Date: Apr. 4, 2019

(54) Blowing Agent Composition for Preparation of a Foam

(71) Applicant: The Chemours Company FC, LLC, Wilmington, DE (US)

(72) Inventor: Ernest Byron Wysong, Chadds Ford, PA (US)

(21) Appl. No.: 16/146,589

(22) Filed: Sep. 28, 2018

Related U.S. Application Data
(60) Provisional application No. 62/565,655, filed on Sep. 29, 2017.

(51) Int. Cl. C08J 9/14; C08J 9/00

(52) U.S. Cl. CPC C08J 9/146; C08J 9/0023; C08J 9/0042; C08J 2205/052; C08J 2203/162; C08J 2375/04; C08J 2201/03; C08J 2203/182

(57) ABSTRACT

Disclosed herein are compositions comprising hydrofluoroolefin blowing agents and a polyol blend useful in forming foams. Also disclosed are methods for forming a foam comprising the aforementioned compositions.

### CROSS-REFERENCE TO RELATED APPLICATIONS

This application claims the benefit of U.S. Provisional Application Ser. No. 62/565,655, filed Sep. 29, 2017, the disclosure of which is incorporated herein by reference in its entirety.

### FIELD OF THE INVENTION

The disclosure herein relates to compositions comprising one or more hydrofluoroolefin blowing agents and a polyol blend. The compositions may further comprise a blowing agent enhancer. The disclosure herein further relates to the use of the compositions in processes for manufacturing foams as well as to foams made from the compositions.

### BACKGROUND OF THE INVENTION

Closed-cell polyisocyanate-based foams are widely used for insulation purposes, for example, in building construction and in the manufacture of energy efficient electrical appliances. In the construction industry, polyurethane (polyisocyanurate) board stock is used in roofing and siding for its insulation and load-carrying capabilities. Poured and sprayed polyurethane foams are widely used for a variety of applications including insulating roofs, insulating large structures such as storage tanks, insulating appliances such as refrigerators and freezers, insulating refrigerated trucks and railcars, etc.

All of these various types of polyurethane foams require blowing (expansion) agents for their manufacture. Insulating foams depend on the use of halocarbon blowing agents, not only to foam the polymer, but also for their low vapor thermal conductivity, a very important characteristic for insulation value. Historically, polyurethane foams used CFCs (chlorofluorocarbons, for example CFC-11, trichlorofluoromethane) and HCFCs (hydrochlorofluorocarbons, for example HCFC-141b, 1,1-dichloro-1-fluoroethane) as the primary blowing agents.

In general, CFCs produce foams exhibiting good thermal insulation, low flammability, and excellent dimensional stability. However, despite these advantages, CFCs have fallen into disfavor due to the implication of chlorine-containing molecules in the destruction of stratospheric ozone. Further, the production and use of CFCs has been restricted by the Montreal Protocol. HCFCs have been proposed as CFC substitutes, and are currently employed as foam blowing agents. However, HCFCs have also been shown to contribute to the depletion of stratospheric ozone, and as a result their use has come under scrutiny. The widespread use of HCFCs is scheduled for eventual phase out under the Montreal Protocol.

Hydrofluoroolefins (HFOs) represent a class of compounds being used as blowing agents in polyurethane and related foams. Spray polyurethane foam (SPF) is a growing important market segment in the rigid insulation industry due to its excellent thermal performance and building envelope sealing capability. When applied, the speed and quality of the applied layers is critical for effective application and efficiency of performance parameters, including density and surface appearance. In addition, such foams are applied in situ in the buildings of interest under a variety of environmental conditions, including cold winter time temperatures. Typical physical foam expansion agents require heat to evaporate and expand. This becomes difficult in cold temperatures when the catalysis of the polyurethane polymerization is slowed, thus diminishing the only source of heat on the surface of the sprayed area. Therefore, providing a means of applying SPF with efficient lay down and under cold conditions represents a benefit for the industry. Further, many HFOs react and decompose in the atmosphere relatively quickly. Thus, many HFOs have no or very low global warming potential (GWP) and do not contribute to the depletion of stratospheric ozone and global warming.

In the past, companies would add a low boiling, gaseous molecule as a co-blowing agent with ambient temperature blowing agents as a means of inducing greater expansion and efficiency at low temperatures. HFO blowing agents have been developed that do not provide significant expansion at sub-freezing temperatures. Other commercially available HFO blowing agents, such as those with lower boiling points, for example, HFO-1234ze, with a boiling point of −19° C., show a strong tendency to decompose when blended and stored in SPF formulations. Further, the blowing agent needs to dissolve in the polyol(s) without separating, particularly during storage.

There is a need for compositions that employ a blowing agent which is soluble and remains soluble in a polyol or mixture of polyols. There is also a need for a composition used in producing foams that is stable and shows improved application behavior, for example, improved density, appearance, and ease of lay down.

### INCORPORATION BY REFERENCE

All publications, patents, and patent applications mentioned in this specification are herein incorporated by reference to the same extent as if each individual publication, patent, or patent application was specifically and individually indicated to be incorporated by reference. In case of conflict, the present application, including any definitions herein, will control.

### SUMMARY OF THE INVENTION

Disclosed herein are compositions (B-side compositions) that are useful in making foams, for example, polyisocyanate foams. The compositions disclosed herein comprise: i) a hydrofluoroolefin blowing agent having the formula Z—CF₃CH═CHCF₃ or E-CF₃CH═CHCF₃, or a mixture thereof; ii) a polyol blend comprising (a) one or more polyester polyols and (b) one or more polyether polyols; and iii) a blowing agent enhancer comprising one or more triols or glycol ethers.

In some embodiments, the blowing agent comprises between about 5% and about 30% by weight of the composition; or between about 8% and about 25% by weight of the composition; or between about 8% and about 10% by weight of the composition.

In some embodiments, the blowing agent is Z—CF₃CH═CHCF₃. In some embodiments, the blowing agent is E-CF₃CH═CHCF₃. In some embodiments, the blowing agent comprises Z—CF₃CH═CHCF₃ and E-CF₃CH═CHCF₃. In some embodiments, the Z—CF₃CH═CHCF₃ and E-CF₃CH═CHCF₃ are present in a weight ratio of about 10:1 to about 1:10 Z—CF₃CH═CHCF₃ to E-CF₃CH═CHCF₃, for example, from about 10:1 to about 1:10, from about 10:1 to about 1:8, from about 10:1 to about 1:6, from about 10:1 to about 1:4, from about 10:1 to about 1:2, from about 8:1 to about 1:10, from about 8:1 to about 1:8, from about 8:1 to about 1:6, from about 8:1 to about 1:4, from about 8:1 to about 1:2, about 6:1 to about 1:10, from about 6:1 to about 1:8, from about 6:1 to about 1:6, from about 6:1 to about 1:4, from about 6:1 to about 1:2, about 4:1 to about 1:10, from about 4:1 to about 1:8, from about 4:1 to about 1:6, from about 4:1 to about 1:4, from about 4:1 to about 1:2, about 2:1 to about 1:10, from about 2:1 to about 1:8, from about 2:1 to about 1:6, from about 2:1 to about 1:4, from about 2:1 to about 1:2, or about 1:1. In some embodiments, the Z—CF₃CH═CHCF₃ and E-CF₃CH═CHCF₃ are present in a weight ratio of about 80:20 or 60:40 or 50:50 or 40:60 or 20:80 Z—CF₃CH═CHCF₃ to E-CF₃CH═CHCF₃.

The polyol blend may comprise any ratio of polyester polyol to polyether polyol One or more of each polyester polyol and polyether polyol may be used. In some embodiments, the polyol blend comprises a weight ratio of about 1:1 to about 2:1 polyester polyol to polyether polyol. In some embodiments, the polyol blend comprises a weight ratio of about 1:1 polyester polyols to polyether polyols. In some embodiments, the polyol blend comprises a weight ratio of about 1:1 polyester polyol to polyether polyol. Other embodiments may comprise other weight ratios of polyester polyols to polyether polyols.

Disclosed herein are compositions comprising a blowing agent enhancer. The blowing agent enhancer may be chosen from one or more triols and glycol ethers.

Disclosed herein are compositions comprising a triol. The triol may be or comprise an oxypropylated polyether triol. In some embodiments, the triol has an average molecular weight of from about 800 to about 1200 g/mol, such as about an average molecular weight of about 1000 g/mol. In some embodiments, the triol has an average hydroxyl number of from about 150 to about 200 mg KOH/gram, such as an average hydroxyl number of from about 165 to about 175 mg KOH/gram. In some embodiments, greater than about 95% of the hydroxyl groups on the triol are secondary hydroxyl groups.

The blowing agent enhancer may comprise one or more glycol ethers. The glycol ether may be chosen from 2-methoxyethanol, 2-ethoxyethanol, 2-propoxyethanol, 2-isopropoxyethanol, 2-butoxyethanol (butyl cellosolve), 2-phenoxyethanol, 2-benzyloxyethanol, 2-(2-methoxyethoxy)ethanol (methyl carbitol), 2-(2-ethoxyethoxy)ethanol (carbitol cellosolve), 2-(2-butoxyethoxy)ethanol (butyl carbitol), propylene glycol phenyl ether, propylene glycol methyl ether (1-methoxy-2-propanol), ethylene glycol phenyl ether, propylene glycol n-propyl ether, propylene glycol n-butyl ether (3-butoxypropan-2-ol), dipropylene glycol methyl ether, and hexyl carbitol. In some embodiments, the glycol ether comprises 2-butoxyethanol.

Disclosed herein are compositions wherein the blowing agent enhancer further comprises a surfactant selected from the group consisting of a liquid or solid organosilicone compound, a polyethylene glycol ether of a long chain alcohol, a tertiary amine or alkanolamine salt of a long chain alkyl acid sulfate ester, an alkyl sulfonic ester, and an alkyl arylsulfonic acid. In some embodiments, the surfactant is a liquid or solid organosilicone compound.

Disclosed herein are compositions wherein the blowing agent enhancer comprises about 60% to about 95% 2-butoxyethanol and about 5% about 40% surfactant, such as about 70% to about 80% 2-butoxyethanol and about 20% to about 30% surfactant. In some embodiments, the blowing agent enhancer comprises about 0.5% to about 5% by weight of the composition.

Disclosed herein are compositions comprising a hydrofluoroolefin blowing agent comprising E-CF₃CH═CHCF₃; a polyol blend comprising polyester polyols and polyether polyols; and an oxypropylated polyether triol.

Also disclosed herein are compositions comprising a hydrofluoroolefin blowing agent comprising E-CF₃CH═CHCF₃; a polyol blend comprising polyester polyols and polyether polyols; and a blowing agent enhancer comprising 2-butoxyethanol.

Also disclosed herein are compositions comprising a hydrofluoroolefin blowing agent that is a mixture of Z—CF₃CH═CHCF₃ and E-CF₃CH═CHCF₃; a polyol blend comprising polyester polyols and polyether polyols; and a blowing agent enhancer comprising 2-butoxyethanol.

Also disclosed herein are compositions comprising a hydrofluoroolefin blowing agent comprising E-CF₃CH═CHCF₃, wherein the hydrofluoroolefin blowing agent comprises between about 5% and about 30% by weight of the composition; or between about 8% and about 25% by weight of the composition; or between about 8% and about 10% by weight of the composition; a polyol blend comprising a weight ratio of about 1:1 polyester polyol to polyether polyol; and a blowing agent enhancer comprising an oxypropylated polyether triol. The oxypropylated polyether glycol may have an average molecular weight of about 1000 g/mol and an average hydroxyl number of from about 165 to about 175 mg KOH/gram.

Also disclosed herein are compositions comprising a hydrofluoroolefin blowing agent comprising E-CF₃CH═CHCF₃, wherein the hydrofluoroolefin blowing agent comprises between about 5% and about 30% by weight of the composition; or between about 8% and about 25% by weight of the composition; or between about 8% and about 10% by weight of the composition; a polyol blend comprising a weight ratio of about 1:1 of polyester polyols to polyether polyols; and a blowing agent enhancer comprising about 70% to about 80% 2-butoxyethanol and about 20% to about 30% of a surfactant, wherein the blowing agent enhancer comprises between about 0.5% to about 5% by weight of the composition.

Also disclosed herein are compositions comprising a hydrofluoroolefin blowing agent that comprises Z—CF₃CH═CHCF₃ and E-CF₃CH═CHCF₃. The weight ratio of Z—CF₃CH═CHCF₃ to E-CF₃CH═CHCF₃ may vary. For example, the composition may comprise any weight ratio, such as about 1:10 or about 10:1 10:1 to about 1:10 Z—CF₃CH═CHCF₃ to E-CF₃CH═CHCF₃, for example, from about 10:1 to about 1:10, from about 10:1 to about 1:8, from about 10:1 to about 1:6, from about 10:1 to about 1:4, from about 10:1 to about 1:2, from about 8:1 to about 1:10, from about 8:1 to about 1:8, from about 8:1 to about 1:6, from about 8:1 to about 1:4, from about 8:1 to about 1:2, about 6:1 to about 1:10, from about 6:1 to about 1:8, from about 6:1 to about 1:6, from about 6:1 to about 1:4, from about 6:1 to about 1:2, about 4:1 to about 1:10, from about 4:1 to about 1:8, from about 4:1 to about 1:6, from about 4:1 to about 1:4, from about 4:1 to about 1:2, about 2:1 to about 1:10, from about 2:1 to about 1:8, from about 2:1 to about 1:6, from about 2:1 to about 1:4, from about 2:1 to about 1:2, or about 1:1. In some embodiments, the Z—CF₃CH═CHCF₃ and E-CF₃CH═CHCF₃ are present in a weight ratio of about 80:20 or 60:40 or 50:50 or 40:60 or 20:80 Z—CF₃CH═CHCF₃ to E-CF₃CH═CHCF₃. The polyol blend may comprise any weight ratio of polyester polyol to polyether polyol, such as a weight ratio of about 1:10 or about 1:8 or about 1:4 or about 1:2 or about 1:1 or about 2:1 or about 4:1 or about 8:1 or about 10:1 polyester polyol to polyether polyol; and a blowing agent enhancer comprising one or more glycol ethers, wherein the blowing agent enhancer comprises between about 0.5% to about 5% by weight of the composition.

Also disclosed herein are compositions further comprising one or more additives selected from the group consisting of a catalyst, a surfactant, and a flame retardant.

Also disclosed herein are compositions wherein the blowing agent remains soluble in the composition without separating from the polyol blend for at least 6 months.

Also disclosed herein are compositions that are foamable compositions.

Also disclosed herein are spray polyurethane foams, prepared from the compositions disclosed herein.

Disclosed herein are foams prepared from a composition comprising a hydrofluoroolefin blowing agent comprising E-CF₃CH═CHCF₃, wherein the hydrofluoroolefin blowing agent comprises between about 5% and about 30% by weight of the composition; or between about 8% and about 25% by weight of the composition; or between about 8% and about 10% by weight of the composition; a polyol blend comprising a polyester polyol and a polyether polyol; and a blowing agent enhancer comprising an oxypropylated polyether triol with an average molecular weight of about 1000 g/mol and an average hydroxyl number of from about 165 to about 175 mg KOH/gram.

Disclosed herein are foams prepared from a composition comprising a hydrofluoroolefin blowing agent comprising E-CF₃CH═CHCF₃. The hydrofluoroolefin blowing agent comprises between about 5% and about 30% by weight of the composition; or between about 8% and about 25% by weight of the composition; or between about 8% and about 10% by weight of the composition; a polyol blend comprising a weight ratio of about 1:1 or about 1:2 or about 2:1 or about 3:1 or about 1:3 polyester polyol to polyether polyol; and a blowing agent enhancer comprising about 70% to about 80% 2-butoxyethanol and about 20% to about 30% of a surfactant, wherein the blowing agent enhancer comprises between about 0.5% to about 5% by weight of the composition.

Disclosed herein are foams prepared from a composition comprising a hydrofluoroolefin blowing agent that is a mixture of Z—CF₃CH═CHCF₃ and E-CF₃CH═CHCF₃ present in a weight ratio of about 4:1 Z—CF₃CH═CHCF₃ to E-CF₃CH═CHCF₃; a polyol blend comprising a weight ratio of about 1:1 to about 2:1 polyester polyols to polyether polyols; and a blowing agent enhancer comprising one or more glycol ethers, wherein the blowing agent enhancer comprises between about 0.5% to about 5% by weight of the composition.

Also disclosed herein are foams prepared from a composition disclosed herein that have a k-factor after one month of aging at 50° F. of about 0.19 Btu·in/ft²·h·° F. or less, or 0.17 Btu·in/ft²·h·° F. or less, or 0.16 Btu·in/ft²·h·° F. or less.

Also disclosed herein are foams prepared from a composition disclosed herein that have a k-factor after one month of aging at 75° F. of about 0.2 Btu·in/ft²·h·° F. or less, or 0.19 Btu·in/ft²·h·° F. or less, or 0.18 Btu·in/ft²·h·° F. or less, or 0.17 Btu·in/ft²·h·° F. or less.

Also disclosed herein are foams prepared from a composition disclosed herein that have a density of from about 2.5 to about 3.5 g/cm³.

Also disclosed herein are methods of forming a foam comprising reacting or extruding a composition disclosed herein under conditions effective to form a foam.

In some embodiments of the method disclosed herein, the foam is a closed cell foam.

Other objects and advantages will become apparent to those skilled in the art upon reference to the detailed description that hereinafter follows.

### DETAILED DESCRIPTION OF THE INVENTION

The production of polyurethane foams typically involves a polyol pre-mixture (typically referred to as the B-side) that comprises one or more blowing agents. This B-side composition will form foam when mixed with a diisocyanate such as a polymeric methylene diphenyl diisocyanate (MDI) mixture (typically referred to as the A-side). The B-side composition should remain chemically and thermally stable before being mixed with the A-side formulation to prevent problems such as the creation of undesirable byproducts, decomposition of B-side components, undesired polymerization, etc. These can decrease the efficiency of the foaming formulation, produce toxic or reactive components, and produce more volatile components that could increase the pressure of the B-side container.

It is found herein that the solubility of hydrofluoroolefins in a B-side composition comprising a blend of polyols is unexpectedly improved in the presence of a blowing agent enhancer, which may comprise a triol or a glycol ether. B-side compositions comprising one or more hydrofluoroolefins, such as hydrofluoroolefins of the formula CF₃CH═CHCF₃, for example Z—CF₃CH═CHCF₃ and E-CF₃CH═CHCF₃, and a blowing agent enhancer, which may comprise a triol or a glycol ether in a blend of polyols will have an extended shelf life. For example, such compositions are stable for at least about 6 months, as compared to B-side compositions comprising the same hydrofluoroolefin blowing agent that do not include a blowing agent enhancer and a blend of polyols, which fail to exhibit such stability.

Disclosed herein are compositions (B-side compositions) comprising a hydrofluoroolefin blowing agent and a blend of polyols, for example, a blend of polyols comprising polyester polyols and polyether polyols. In some embodiments, the compositions further comprise a triol. In some embodiments, the compositions further comprise a blowing agent enhancer, for example, a glycol ether. The blowing agent enhancer improves the efficiency of the hydrofluoroolefin blowing agent in the preparation of rigid polyurethane foams. In some embodiments, the B-side composition remains chemically and thermally stable before being mixed with the A-side formulation. As used herein, the term “polyurethane” is intended to mean polyurethane and/or polyisocyanurate, as is understood in the art. Thus a rigid polyurethane foam can be a rigid polyurethane and/or polyisocyanurate foam.

Hydrofluoroolefins

The compositions disclosed herein comprise one or more hydrofluoroolefin blowing agents comprising Z—CF₃CH═CHCF₃ (Z-1,1,1,4,4,4-hexafluoro-2-butene; Z-1336mzz) or E-CF₃CH═CHCF₃ (E-1,1,1,4,4,4-hexafluoro-2-butene; E-1336mzz). In some embodiments, the hydrofluoroolefin blowing agent is Z—CF₃CH═CHCF₃. In some embodiments, the hydrofluoroolefin blowing agent is E-CF₃CH═CHCF₃. In some embodiments, the hydrofluoroolefin blowing agent is a mixture of Z—CF₃CH═CHCF₃ and E-CF₃CH═CHCF₃.

In some embodiments, the hydrofluoroolefin comprises between about 5% and about 30% by weight of the composition (B-side composition). For example, about 5% to about 25%, about 5% to about 20%, about 5% to about 15%, about 5% to about 10%, about 10% to about 30%, about 10% to about 25%, about 10% to about 20%, about 10% to about 15%, about 15% to about 30%, about 15% to about 25%, about 15% to about 20%, about 20% to about 30%, about 20% to about 25%, or about 25% to about 30%. In some embodiments, the hydrofluoroolefin blowing agent comprises between about 8% and about 25% by weight of the composition, such as between about 8% and about 10% by weight of the composition.

In some embodiments, the blowing agent is a mixture of hydrofluoroolefins, for example, a mixture of Z—CF₃CH═CHCF₃ and E-CF₃CH═CHCF₃. In some embodiments, Z—CF₃CH═CHCF₃ and E-CF₃CH═CHCF₃ are present in a weight ratio of about 10:1 to about 1:10 Z—CF₃CH═CHCF₃ to E-CF₃CH═CHCF₃. For example, a weight ratio of about 10:1, 9:1, 8:1, 7:1, 6:1, 5:1, 4:1, 3:1, 2:1, 3:2, 1:1, 2:3, 1:2, 1:3, 1:4, 1:5, 1:6, 1:7, 1:8, 1:9, or 1:10 Z—CF₃CH═CHCF₃ to E-CF₃CH═CHCF₃. In some embodiments, Z—CF₃CH═CHCF₃ and E-CF₃CH═CHCF₃ are present in a weight ratio of about 4:1 Z—CF₃CH═CHCF₃ to E-CF₃CH═CHCF₃.

In the use of a mixture of hydrofluoroolefin blowing agents, e.g., a mixture of Z—CF₃CH═CHCF₃ and E-CF₃CH═CHCF₃, for making a foamed reaction product, for example, a polyurethane foam, one blowing agent can be added prior to mixing with the other components in the composition. Alternatively, one blowing agent can be mixed with some or all of the other components before the other is mixed in. For example, the Z-isomer can be first mixed with the other components in the composition before the E-isomer is added.

Polyols

The compositions disclosed herein comprise a blend of polyols, i.e., compounds having at least two hydroxyl groups per molecule. In some embodiments, the polyol blend is a blend of polyester polyols and polyether polyols.

In some embodiments, the compositions comprise one or more polyester polyols. Suitable polyester polyols include those prepared by reacting a carboxylic acid and/or a derivative thereof or a polycarboxylic anhydride with a polyhydric alcohol. The polycarboxylic acids can be any of the known aliphatic, cycloaliphatic, aromatic, and/or heterocyclic polycarboxylic acids and can be substituted (e.g., with halogen atoms) and/or unsaturated. Examples of suitable polycarboxylic acids an d anhydrides include oxalic acid, malonic acid, glutaric acid, pimelic acid, succinic acid, adipic acid, suberic acid, azelaic acid, sebacic acid, phthalic acid, isophthalic acid, terephthalic acid, trimellitic acid, trimellitic acid anhydride, pyromellitic dianhydride, phthalic acid anhydride, tetrahydrophthalic acid anhydride, hexahydrophthalic acid anhydride, endomethylene tetrahydrophthalic acid anhydride, glutaric acid anhydride acid, maleic acid, maleic acid anhydride, fumaric acid, and dimeric and trimeric fatty acids, such as those of oleic acid which may be in admixture with monomeric fatty acids. Simple esters of polycarboxylic acids can also be used, such as terephthalic acid dimethylester, terephthalic acid bisglycol and extracts thereof. The polyhydric alcohols suitable for the preparation of polyester polyols can be aliphatic, cycloaliphatic, aromatic, and/or heterocyclic. The polyhydric alcohols optionally can include substituents which are inert in the reaction, for example, chlorine and bromine substituents, and/or may be unsaturated. Suitable amino alcohols, such as monoethanolamine, diethanolamine or the like can also be used. Examples of suitable polyhydric alcohols include ethylene glycol, propylene glycol, polyoxyalkylene glycols (such as diethylene glycol, polyethylene glycol, dipropylene glycol and polypropylene glycol), glycerol, and trimethylolpropane.

Other suitable polyester polyols include aromatic polyester polyols, e.g., those made by transesterifying polyethylene terephthalate (PET) scrap with a glycol such as diethylene glycol, or made by reacting phthalic anhydride with a glycol. The resulting polyester polyols can be reacted further with ethylene and/or propylene oxide to form an extended polyester polyol containing additional internal alkyleneoxy groups.

In some embodiments, the polyester polyol is a modified aromatic polyester polyol. In some embodiments, the polyester polyol has an average molecular weight of from about 400 g/mol to about 500 g/mol, such as from about 450 g/mol to about 475 g/mol. In some embodiments, the polyester polyol is an aromatic polyester polyol with an average hydroxyl number of from about 200 to about 325, such as from about 235 to about 265, or about 230 to about 250, or about 295 to about 315. Exemplary polyester polyols that are commercially available include the polyester polyols Stepanpol® PS-2353 (Stepan Company, Chicago, Ill.), Stepanpol® PS-2502A (Stepan Company, Chicago, Ill.), Terol® 256 (Huntsman, The Woodlands, Tex.), and Terol® 925 (Huntsman, The Woodlands, Tex.).

In some embodiments, the compositions comprise one or more polyether polyols. Examples of suitable polyether polyols include, but are not limited to, polyethylene oxides, polypropylene oxides, mixed polyethylene-propylene oxides with terminal hydroxyl groups, among others. Other suitable polyols can be prepared by reacting ethylene and/or propylene oxide with an initiator having 2 to 16, generally 3 to 8 hydroxyl groups as present, for example, in glycerol, pentaerythritol and carbohydrates such as sorbitol, glucose, sucrose and the like polyhydroxy compounds. Suitable polyether polyols can also include aliphatic or aromatic amine-based polyols.

In some embodiments, the polyether polyol is a medium functional polyether polyol. For example, the polyether polyol has a functionality of about four. In some embodiments, the polyether polyol is sucrose/glycerin initiated. In some embodiments, the polyether polyol is a Mannich-based polyether polyol. As used herein, the term “Mannich-based polyol” refers to an aromatic polyol obtained by alkoxylation with propylene oxide and/or ethylene oxide of the Mannich bases obtained by classical Mannich reaction between phenols (e.g., phenol, p-nonylphenol), formaldehyde and alkanolamines (diethanolamine, diisopropanolamine, monoethanolamine, monoisopropanolamine, etc.). In some embodiments, the polyether polyol has an average molecular weight of from about 450 g/mol to about 475 g/mol. In some embodiments, the polyether polyol has an average hydroxyl number of from about 400 to about 525, such as from about 475 to about 510, or about 415 to about 430, or about 460 to about 480, or about 425, or about 470. Exemplary commercially available polyether polyols include Voranol® 490 (Dow Chemical, Midland, Mich.), Carpol® MX-425 (Carpenter Co., Richmond, Va.), and Carpol® MX-470 (Carpenter Co., Richmond, Va.).

In some embodiments, the blend of polyols is a blend of polyester polyols and polyether polyols. In some embodiments, the polyol blend comprises a weight ratio of about 1:2 or about 2:1 or about 1:3 or about 3:1 polyester polyol to polyether polyol, such as about 1:1 to about 2:1 weight ratio of polyester polyol to polyether polyol. In some embodiments, the polyol blend comprises a weight ratio of about 1:1 polyester polyols to polyether polyols. In some embodiments, the polyol blend comprises a 1.9:1 weight ratio of polyester polyols to polyether polyols.

In some embodiments, the blowing agent is soluble in the polyol blend, for example, the solubility of the blowing agent in the polyol blend is from about 6 to about 12 parts by weight (pbw), such as from about 8 to about 10 pbw. In some embodiments, the blowing agent remains soluble in the composition without separating from the polyol blend for at least 6 months. In some embodiments, solubility is measured by visual assessment. For example, the solubility of the blowing agent in the composition can be assessed visually in clear, aerosol bottles containing the formulation.

Blowing Agent Enhancers

In some embodiments, the composition further comprises a blowing agent enhancer. A “blowing agent enhancer,” as used herein, is an agent that can promote improved blowing agent solubility as well as improved overall system handling by reducing the viscosity of the B-side composition. Improved blowing agent solubility can be demonstrated by a reduction in the vapor pressure of the B-side composition, allowing more of the blowing agent(s) to be retained in the foam throughout application, leading to improved blowing agent utilization or improved yields in SPF formulations.

The blowing agent enhancers of the compositions disclosed herein are useful in the reaction of a polyisocyanate and a polyol in the presence of a hydrofluoroolefin blowing agent. Typically, the reaction is performed in the presence of a urethane catalyst, and typically in the presence of a surfactant.

The blowing agent enhancer may be a triol. In some embodiments, the triol is a polyether triol, such as an oxypropylated polyether triol. In some embodiments, the triol has an average molecular weight of from about 250 g/mol to about 7000 g/mol, for example, an average molecular weight of from about 500 g/mol to about 6000 g/mol, about 600 g/mol to about 5000 g/mol, about 700 g/mol to about 3500 g/mol, about 800 g/mol to about 2500 g/mol, about 800 g/mol to about 2000 g/mol, or about 800 g/mol to about 1200 g/mol. In some embodiments, the trio has an average molecular weight of from about 800 g/mol to about 1200 g/mol. In some embodiments, the triol has an average molecular weight of about 1000 g/mol.

In some embodiments, the triol has an average hydroxyl number of from about 20 mg KOH/g to about 650 mg KOH/g, for example, an average hydroxyl number of from about 50 mg KOH/g to about 500 mg KOH/g, about 75 mg KOH/g to about 300 mg KOH/g, about 100 mg KOH/g to about 200 mg KOH/g, about 150 mg KOH/g to about 200 mg KOH/g, or about 165 mg KOH/g to about 175 mg KOH/g. In some embodiments, the triol has an average molecular hydroxyl number of from about 165 mg KOH/g to about 175 mg KOH/g. In some embodiments, the triol has an average molecular hydroxyl number of about 168 mg KOH/g.

In some embodiments, greater than about 95% of the hydroxyl groups on the triol are secondary hydroxyl groups. For example, greater than 95%, 96%, 97%, 98%, 99%, or 100% of the hydroxyl groups on the triol are secondary hydroxyl groups. In some embodiments, 100% of the hydroxyl groups on the triol are secondary hydroxyl groups.

In some embodiments, the triol is an oxypropylated polyether triol with a molecular weight of about 1000 g/mol having a hydroxyl number of from about 165 mg KOH/g to about 175 mg KOH/g and approximately 100% secondary hydroxyl groups. A suitable commercially available triol is Poly-G® 30-168 (Monument Chemical, Brandenburg, Ky.). Other commercially available polyether triols of similar characteristics can also be used.

In some embodiments, the blowing agent enhancer comprises one or more glycol ethers. In some embodiments, the blowing agent enhancer comprises a glycol ether.

Examples of suitable blowing agent enhancers include, but are not limited to glycol ethers, for example, 2-methoxyethanol, 2-ethoxyethanol, 2-propoxyethanol, 2-isopropoxyethanol, 2-butoxyethanol (butyl cellosolve), 2-phenoxyethanol, 2-benzyloxyethanol, 2-(2-methoxyethoxy)ethanol (methyl carbitol), 2-(2-ethoxyethoxy)ethanol (carbitol cellosolve), 2-(2-butoxyethoxy)ethanol (butyl carbitol), propylene glycol phenyl ether, propylene glycol methyl ether (1-methoxy-2-propanol), ethylene glycol phenyl ether, propylene glycol n-propyl ether, propylene glycol n-butyl ether (3-butoxypropan-2-ol), dipropylene glycol methyl ether, and hexyl carbitol. In some embodiments, the glycol ether comprises 2-butoxyethanol.

In some embodiments, the blowing agent enhancer further comprises a surfactant. For example, the blowing agent enhancer can be a mixture of a glycol ether and a surfactant. Suitable surfactants include, but are not limited to, a liquid or solid organosilicone compound, a polyethylene glycol ether of a long chain alcohol, a tertiary amine or alkanolamine salt of a long chain alkyl acid sulfate ester, an alkyl sulfonic ester, and an alkyl arylsulfonic acid. In some embodiments, the surfactant is a liquid or solid organosilicone surfactant.

In some embodiments, the blowing agent enhancer is a mixture of a glycol ether and a surfactant. For example, in some embodiments, the blowing agent enhancer is a mixture of 2-butoxyethanol and a surfactant, such as an organosilicone surfactant. In some embodiments, the glycol ether comprises about 60% to about 95% of the blowing agent enhancer, such as, for example, about 70% to about 80%, or about 75% of the blowing agent enhancer. In some embodiments, the surfactant comprises about 5% to about 40% of the blowing agent enhancer, such as, for example, about 20% to about 30%, or about 25% of the blowing agent enhancer. In some embodiments, the blowing agent enhancer comprises about 60% to about 95% 2-butoxyethanol and about 5% about 40% organosilicone surfactant, such as about 70% to about 80% 2-butoxyethanol and about 20% to about 30% organosilicone surfactant. In some embodiments, the blowing agent enhancer comprises about 75% 2-butoxyethanol and about 25% organosilicone surfactant.

In some embodiments, the blowing agent enhancer can be present in the B-side composition in an amount of about 0.5% to about 5% by weight of the composition. For example, about 0.5% to about 4.5%, about 0.5% to about 4%, about 0.5% to about 3%, about 0.5% to about 2%, about 0.5% to about 1%, about 1% to about 5%, about 1% to about 4%, about 1% to about 3%, about 1% to about 2%, about 2% to about 5%, about 2% to about 4%, about 2% to about 3%, and about 1.5% to about 3.5% of the composition.

Additives

In some embodiments, one or more additives can be included in the compositions described herein. For example, the compositions can further comprise one or more additives that include, but are not limited to, catalysts, surfactants, flame retardants, stabilizers, preservatives, chain extenders, cross-linkers, water, colorants, antioxidants, reinforcing agents, fillers, antistatic agents, nucleating agents, smoke suppressants, and pigments.

In some embodiments, the compositions described herein further comprise a surfactant. Suitable surfactants can comprise a liquid or solid organosilicone compound. Other surfactants include polyethylene glycol ethers of long chain alcohols, tertiary amine or alkanolamine salts of long chain alkyl acid sulfate esters, alkyl sulfonic esters, and alkyl arylsulfonic acids. In some embodiments, the compositions comprise a silicone surfactant.

One or more catalysts for the reaction of the polyol with the polyisocyanate can also be included in the compositions described herein. Typically, urethane formulations are prepared using a spectrum of catalysts based on the type of reaction; for example, a “Blow Reaction” on one side of the spectrum and a “Gel Reaction” on the other side of the spectrum. Exemplary catalysts useful for blowing reactions include, but are not limited to, BDMAEE (Bis-(2-dimethylaminoethyl)ether, DABCO BL-19®, JEFFCAT ZF-20®, (TOYOCAT ETS). An exemplary catalyst useful for a gel reaction includes, but is not limited to, DMCHA (N,N-dimethylcyclohexylamine, i.e., as Polycat 8®). Any suitable urethane catalyst can be used, including amine-based compounds, such as tertiary amine compounds, for example, dimethylethanolamine and bis(2-dimethylamino ethyl) ether, and organometallic compounds. Such catalysts are used in an amount which increases the rate of reaction of the polyisocyanate. By way of example, typical amounts of catalyst used are about 0.1 to about 5 parts of catalyst per 100 parts by weight of polyol. In some embodiments, the catalyst comprises a gel catalyst, such as a non-nucleophilic gel catalyst. In some embodiments, the catalyst comprises a blow catalyst. In some embodiments, the catalyst comprises a metal catalyst.

In some embodiments, the compositions comprise a flame retardant. Useful flame retardants include, but are not limited to, tris(2-chloroethyl) phosphate, tris(2-chloropropyl) phosphate, tris(1-chloro-2-propyl) phosphate (TCPP), tris(2,3-dibromopropyl) phosphate, tris(1,3-dichloropropyl) phosphate, diammonium phosphate, various halogenated aromatic compounds, antimony oxide, aluminum trihydrate, polyvinyl chloride, bromine-containing diester/ether diols of tetrabromophthalic anhydride, such as a mixed ester of tetrabromophthalic anhydride with diethylene glycol and propylene glycol. Exemplary commercially available flame retardants include, for example, Saytex® RB-79, a reactive bromine-containing diester/ether diol of tetrabromophthalic anhydride (Albemarle Corporation, Baton Rouge, La.).

Foams and Methods of Forming a Foam

Polyurethane foams require blowing agents for their manufacture. Insulating foams depend on the use of halocarbon blowing agents, such as hydrofluoroolefin blowing agents, not only to foam the polymer, but primarily for their low vapor thermal conductivity, a very important characteristic for insulation value. Thus, disclosed herein are foams prepared from a B-side composition containing a hydrofluoroolefin blowing agent. The types of foam can include, for example, closed cell foams, open cell foams, rigid foams, flexible foams, and integral skin. In some embodiments, disclosed herein are foams prepared from the compositions (B-side compositions) described herein comprising a hydrofluoroolefin blowing agent and a blend of polyols, for example, a blend of polyols comprising polyester polyols and polyether polyols. In some embodiments, the compositions further comprise a triol. In some embodiments, the compositions further comprise a blowing agent enhancer, for example, a glycol ether.

In some embodiments, the foams disclosed herein can be used in a wide variety of applications, including, but not limited to, appliance foams including refrigerator foams, freezer foams, refrigerator/freezer foams, panel foams, and other cold or cryogenic manufacturing applications. In some embodiments, the foams formed from the compositions disclosed herein have exceptional thermal performance, such as can be measured by the k-factor. “K-factor,” as used herein, represents the foam's thermal conductivity or ability to conduct heat. The k-factor is a measure of heat that passes through one square foot of material that is one-inch-thick in one hour. Typically, the lower the k-factor, the better the insulation. In some embodiments, the foams disclosed herein have a k-factor after aging at around 50° F. of about 0.2 Btu·in/ft²·h·° F. or less, such as about 0.19, 0.18, 0.17, 0.16, or 0.15 Btu·in/ft²·h·° F. or less. In some embodiments, the foams have aged at around 50° F. for about one month. In some embodiments, the foams disclosed herein have a k-factor after aging at around 75° F. of about 0.2 Btu·in/ft²·h·° F. or less, such as about 0.19, 0.18, 0.17, 0.16, or 0.15 Btu·in/ft²·h·° F. or less. In some embodiments, the foams have aged at around 75° F. for about one month.

In some embodiments, the foams produced from the B-side compositions disclosed herein have a density of from about 2.5 to about 3.5 g/cm³. For examples, the foams can have a density of about 2.5, 2.6, 2.7, 2.8, 2.9, 3.0, 3.1, 3.2, 3.3, 3.4, or 3.5 g/cm³.

Also disclosed herein are methods of forming a foam comprising reacting or extruding a composition disclosed herein, e.g., a B-side composition disclosed herein, under conditions effective to form a foam. In some embodiments, the method of forming a foam comprises: (a) adding a B-side composition disclosed herein to a composition comprising an isocyanate; and (b) reacting the compositions under conditions effective to form a foam. The isocyanate or isocyanate-containing mixture can include the isocyanate and auxiliary chemicals, like catalysts, surfactants, stabilizers, chain extenders, cross-linkers, water, fire retardants, smoke suppressants, pigments, coloring materials, fillers, etc. Any of the methods well known in the art, such as those described in “Polyurethanes Chemistry and Technology,” Volumes I and II, Saunders and Frisch, 1962, John Wiley and Sons, New York, N.Y., which is incorporated herein by reference, can be used or adapted for use in accordance with the compositions disclosed herein.

In the process of making a polyisocyanate-based foam, the polyol(s), polyisocyanate and other components are contacted, thoroughly mixed, and permitted to expand and cure into a cellular polymer. The particular mixing apparatus is not critical, and various types of mixing head and spray apparatus are conveniently used. It is often convenient, but not necessary, to pre-blend certain of the raw materials prior to reacting the polyisocyanate and polyols. For example, it is often useful to prepare the B-side composition disclosed herein, and then contact this composition with the polyisocyanate.

In some embodiments, the foam is a rigid, closed-celled polyisocyanate-based foam. It can be prepared by contacting an organic polyisocyanate with a polyol in the presence of a blowing agent, e.g., contacting an organic polyisocyanate with the B-side compositions described herein, characterized in that the so-prepared foam contains within its cells gaseous blowing agents. The rigid closed-cell celled polyisocyanate-based foams are useful in spray insulation, as foam-in-place appliance foams, rigid insulating board stock, or in laminates.

In some embodiments, the B-side composition can be used to blow thermoplastic foams, such as polystyrene, polyethylene foams, including low-density polyethylene foams, or polypropylene foams. Any of a wide range of conventional methods for blowing such thermoplastic foams can be adapted for use herein. Thus, disclosed herein are thermoplastic foams, such as polystyrene, polyethylene (PE), for example, low density PE, or polypropylene (PP), formed using the B-side compositions disclosed herein.

The thermoplastic foam bodies can be produced using conventional equipment comprising an extruder and associated means for (1) melting the resin; (2) homogeneously blending the B-side composition described herein with the melt to form a plasticized mass at non-foaming temperatures and pressures; (3) passing the plasticized mass at a controlled rate, temperature and pressure through a die having a desired shape, e.g., slit die for producing rectangular slabs of foam board having desired thickness and surface area, into an expansion zone; (4) allowing the extrudate to foam in the expansion zone maintainable at suitable temperatures and low pressures; (5) maintaining the expanding extrudate under such temperatures and pressures for a time sufficient for the viscosity of the extrudate to increase such that the cell size and density of the foam remain substantially unchanged and substantially free of ruptured cells at ambient temperature, e.g., 25° C. and atmospheric pressure; and (6) recovering the extruded foam body.

When preparing foams, it is often desirable to add a nucleating agent or other additives into the resin. Nucleating agents serve primarily to increase cell count and decrease cell size in the foam, and can be used in an amount of about 0.1 to about 10 parts by weight per 100 parts by weight of the resin. Typical nucleating agents comprise at least one member selected from the group consisting of talc, sodium bicarbonate-citric acid mixtures, calcium silicate, and carbon dioxide, among others.

In some embodiments, the blowing agent is in the range of from about 1 to about 30 weight percent based on the total weight of the resin plus blowing agent mixture, typically about 2 to 20 weight percent, and normally about 2 to about 10 weight percent. The lower the concentration of blowing agent, the greater the density of the resulting foam. The proper amount of blowing agent or resultant characteristics of the foam for any desired end-use is readily determined by a skilled person in this art. The resin is melted at a temperature of about 200° C. to about 235° C. depending upon the grade employed, and at non-foaming pressures of about 600 psig or higher. The plasticized resin-blowing agent mixture is cooled under non-foaming pressure to a temperature of about 115° C. to 150° C., such as around 130° C., and extruded into the expansion zone at or below ambient temperature and at or below atmospheric pressure.

Representative foamed products that can be made in accordance with the present disclosure include, for example: (1) polystyrene foam sheet for the production of disposable thermoformed packaging materials, e.g., as disclosed in U.S. Pat. No. 5,204,169; (2) extruded polystyrene foam boards for use as residential and industrial sheathing and roofing materials, which may be from about 0.5 to 6 inches (1.25 to 15 cm) thick, up to 4 feet (122 cm) wide, with cross-sectional areas of from 0.17 to 3 square feet (0.016 to 0.28 square meter), and up to 27 feet (813 meters) long, with densities of from about 1.5 to 10 pounds per cubic foot (pcf) (25 to 160 kilograms per cubic meter (kg/m³); (3) expandable foams in the form of large billets which may be up to about 2 feet (61 cm) thick, often at least 1.5 feet 46 cm) thick, up to 4 feet (1.22 meters) wide, up to 16 feet (4.8 meters) long, having a cross-sectional area of about 2 to 8 square feet (0.19 to 0.74 square meter) and a density of from 6 to 15 pcf (96 to 240 kg/m³). Such foamed products are more fully described by Stockdopole and Welsh in the Encyclopedia of Polymer Science and Engineering, vol. 16, pages 193-205, John Wiley & Sons, 1989; hereby incorporated by reference.

### EXAMPLES

The present disclosure is further defined in the following Examples. It should be understood that these Examples, while indicating preferred embodiments, are given by way of illustration only. From the above discussion and these Examples, one skilled in the art can ascertain the preferred features, and without departing from the spirit and scope thereof, can make various changes and modifications to adapt it to various uses and conditions.

### Example 1—Comparative Example

4 g (8 pbw) of the blowing agent E-CF₃CH═CHCF₃ (E-1336mzz) and 2 g (4 pbw) of a blowing agent enhancer comprising 75% 2-butoxyethanol and 25% of a silicone surfactant was added to either a polyether polyol (100 g; Voranol® 490, Dow Chemical, Midland, Mich.) or a polyester polyol (100 g; Stepanpol® PS-2502A, Stepan Company, Chicago, Ill.). The blowing agent E-1336mzz showed separation in both the polyether polyol solution and the polyester polyol solution.

### Example 2

4 g (8 pbw) of the blowing agent E-CF₃CH═CHCF₃ (E-1336mzz) and 2 g (4 pbw) of a blowing agent enhancer comprising 75% 2-butoxyethanol and 25% of a silicone surfactant was added to a blend (1:1 weight ratio) of a polyether polyol (Voranol® 490, Dow Chemical, Midland, Mich.) and a polyester polyol (Stepanpol® PS-2502A, Stepan Company, Chicago, Ill.). After 6 months of storage, no separation of the blowing agent E-1336mzz from the polyol blend was observed.

### Example 3

4 g (8 pbw) of the blowing agent E-CF₃CH═CHCF₃ (E-1336mzz) was added to a mixture containing 20 wt % of a 1000 MW oxypropylated polyether triol (Poly-G® 30-168, Monument Chemical, Brandenburg, Ky.), 40 wt % of a polyether polyol (Voranol® 490, Dow Chemical, Midland, Mich.), and 40 wt % of a polyester polyol (Stepanpol® PS-2502A, Stepan Company, Chicago, Ill.). After 6 months of storage, no separation of the blowing agent E-1336mzz from the mixture was observed.

### Example 4

A series of spray polyurethane foam (SPF) formulations were prepared and are shown below in Tables 1-6. The formulations contained combinations of the following: a polyester polyol with a hydroxyl number of 250 or 300; an aromatic amino polyether polyol; a blowing agent enhancer that contained a glycol ether; the flame retardant tris(2-chloroethyl) phosphate (TCPP); a cross linker; a silicone surfactant; catalysts that included gel catalysts, non-nucleophilic gel catalysts, blow catalysts, and metal catalysts; water; and blowing agents E-CF₃CH═CHCF₃ (E-1336mzz), Z—CF₃CH═CHCF₃ (Z-1336mzz), and 1-chloro-3,3,3-trifluoro-propene (HCFO-1233zd) used as a comparative example.

TABLE 1
Formulation 1 (Z-isomer)

| Components | Wt % |
|---|---|
| Z-1336mzz | 9 |
| Blowing agent enhancer | 3 |
| containing glycol ether | |
| Polyester polyol OH# 250 | 45.9 |
| Aromatic amino polyether | 25 |
| polyol | |
| TCPP | 10 |
| Silicone surfactant | 1 |
| Non-nucleophilic gel | 4 |
| catalyst | |
| Blow catalyst | 1 |
| Metal catalyst | 0.6 |
| Water | 1.5 |
| Total | 100 |

TABLE 2
Formulation 2 (80:20 Z-isomer to E-isomer)

| Components | Wt % |
|---|---|
| Z-1336mzz | 7.2 |
| E-1336mzz | 1.8 |
| Blowing agent enhancer | 3 |
| containing glycol ether | |
| Polyester polyol OH# 250 | 45.9 |
| Aromatic amino polyether | 25 |
| polyol | |
| TCPP | 10 |
| Silicone surfactant | 1 |
| Non-nucleophilic gel | 4 |
| catalyst | |
| Blow catalyst | 1 |
| Metal catalyst | 0.6 |
| Water | 1.5 |
| Total | 100 |

TABLE 3
Formulation 3 (Z-isomer)

| Components | Wt % |
|---|---|
| Z-1336mzz | 10 |
| Blowing agent enhancer | 3 |
| containing glycol ether | |
| Polyester polyol OH# 300 | 32 |
| Aromatic amino polyether | 33.6 |
| polyol | |
| Cross linker | 5 |
| TCPP | 10 |
| Silicone surfactant | 1 |
| Blow catalyst #1 | 0.7 |
| Gel catalyst | 2.6 |
| Blow catalyst #2 | 0.3 |
| Water | 1.8 |
| Total | 100 |

TABLE 4
Formulation 4 (80:20 Z-isomer to E-isomer)

| Components | Wt % |
|---|---|
| Z-1336mzz | 8 |
| E-1336mzz | 2 |
| Blowing agent enhancer | 3 |
| containing glycol ether | |
| Polyester polyol OH# 300 | 32 |
| Aromatic amino polyether | 33.6 |
| polyol | |
| Cross linker | 5 |
| TCPP | 10 |
| Silicone surfactant | 1 |
| Blow catalyst #1 | 0.7 |
| Gel catalyst | 2.6 |
| Blow catalyst #2 | 0.3 |
| Water | 1.8 |
| Total | 100 |

TABLE 5
Formulation 5 (60:40 Z-isomer to E-isomer)

| Components | Wt % |
|---|---|
| Z-1336mzz | 6 |
| E-1336mzz | 4 |
| Polyester polyol OH# 300 | 32 |
| Aromatic amino polyether | 33.6 |
| polyol | |
| Cross linker | 5 |
| TCPP | 10 |
| Silicone surfactant | 1 |
| Blow catalyst #1 | 0.7 |
| Gel catalyst | 2.6 |
| Blow catalyst #2 | 0.3 |
| Water | 1.8 |
| Total | 100 |

TABLE 6
Formulation 6 (HCFO-1233zd) - Comparative Formulation

| Components | Wt % |
|---|---|
| HCFO-1233zd | 10 |
| Blowing agent enhancer | 3 |
| containing glycol ether | |
| Polyester polyol OH# 300 | 32 |
| Aromatic amino polyether | 33.6 |
| polyol | |
| Cross linker | 5 |
| TCPP | 10 |
| Silicone surfactant | 1 |
| Blow catalyst #1 | 0.7 |
| Gel catalyst | 2.6 |
| Blow catalyst #2 | 0.3 |
| Water | 1.8 |
| Total | 100 |

### Example 5

Spray foam trials were conducted using the formulations prepared in Example 4 above. The formulations were blended in appropriate mixing containers, and allowed to sit for several minutes before being applied in a ventilated test facility onto various sized oriented strand board (OSB) samples via a high-pressure proportioner and spray gun assembly. The foams were applied at 6×½ inch lifts, 3×1 inch lifts, or 2 inches in one lift. The equipment and conditions are shown below.

| | |
|---|---|
| Equipment | |
| Proportioner | Gusmer H-20/35 |
| Spray gun | Fusion AR4242 |

| | | | | |
|---|---|---|---|---|
| Hoses | 60 | ft | 18.3 | m |
| Processing conditions | | | | |
| Temperature (A &B) | 130° | F. | 54.4° | C. |
| Pressure (A & B) | 1000 | psi | 69 | bar |
| Ambient temperature | 85° | F. | 29.4° | C. |

| | |
|---|---|
| Humidity | 75% |

Results of trials conducted with Formulation 1 (Z-isomer) and Formulation 2 (80:20 Z-isomer to E-isomer) are shown in Tables 7 and 8, respectively, below.

¹⁹F NMR was used to quantify the amounts of fluorinated, gaseous species in the foam samples. Foam samples were prepared by coring ca. 8.9 mm o.d. cylinders from a larger block. Samples thus prepared were cut to 5.1 cm length and inserted into a cylindrical (10.0 mm o.d.) borosilicate glass NMR tube. NMR spectra were acquired on a Varian 700 MHz VNMRS spectrometer equipped with a 10 mm F, H probe. For the purposes of absolute quantitation, an external standard was prepared containing a known pressure (0.116 bar) of hexafluoroethane. Spectra were acquired of this standard under identical conditions as those used with the foam samples. The pressure of hexafluoroethane was converted to molar concentration by use of the ideal gas law (n/V=P/RT). Concentration was expressed as moles of fluorinated species per liter of foam relative to the hexafluoroethane external standard.

TABLE 7
Formulation 1 (Z-isomer) spray foam trials results

| | Initial k-factor | | | | 1-month k-factor | | ¹⁹F NMR | |
|---|---|---|---|---|---|---|---|---|
| | (Btu · in/ft² · h · ° F.) | | | | (Btu · in/ft² · h · ° F.) | | (mol/L foam) | |
| | Density | Open cell | 50° F. | 75° F. | 50° F. | 75° F. | Z-1336mzz | Wt. basis |
| ½ in. | 3.5 | 4.01 | 0.1530 | 0.1649 | 0.1542 | 0.1666 | 8.76E−03 | 2.57% |
| (6 pass) | | | | | | | | |
| 1 in. | 3.04 | 5.83 | 0.1552 | 0.1677 | 0.1678 | 0.1852 | 6.07E−03 | 2.04% |
| (3 pass) | | | | | | | | |
| 2 in. | 2.78 | 7.14 | 0.1601 | 0.1712 | 0.1802 | 0.195 | 5.74E−03 | 2.11% |
| (1 pass) | | | | | | | | |

TABLE 8
Formulation 2 (80:20 Z-isomer:E-isomer) spray foam trials results

| | Initial k-factor | | | | 1-month k-factor | | ¹⁹F NMR | | |
|---|---|---|---|---|---|---|---|---|---|
| | (Btu · in/ft² · h · ° F.) | | | | (Btu · in/ft² · h · ° F.) | | (mol/L foam) | | |
| | Density | Open cell | 50° F. | 75° F. | 50° F. | 75° F. | Z-1336mzz | Wt. basis | E-1336mzz |
| ½ in. | 3.32 | 13.01 | 0.1507 | 0.1623 | 0.1535 | 0.1662 | 6.70E−03 | 2.63% | 1.86E−03 |
| (6 pass) | | | | | | | | | |
| 1 in. | 2.89 | 10.2 | 0.1517 | 0.1643 | 0.1629 | 0.1781 | 5.53E−03 | 2.53% | 1.58E−03 |
| (3 pass) | | | | | | | | | |
| 2 in. | 2.51 | 6.08 | curved | — | — | — | 3.72E−03 | 1.92% | 9.95E−04 |
| (1 pass) | | | | | | | | | |

### Example 6

Formulations containing Z-1336mzz with and without a blowing agent enhancer (BAE) containing glycol ether and an 80:20 blend of Z-1336mzz/E-1336mzz with and without a blowing agent enhancer containing glycol ether were prepared. The formulations are shown in Table 9 below.

TABLE 9
Formulations with and without blowing agent enhancer

| | | | 80:20 Z- | 80:20 Z- |
|---|---|---|---|---|
| | Z- | Z-1336mzz | 1336mzz/E- | 1336mzz/E- |
| | 1336mzz | with BAE | 1336mzz | 1336mzz with |
| Components | (wt %) | (wt %) | (wt %) | BAE (wt %) |
| Polyester | 35 | 35 | 35 | 35 |
| polyol OH# | | | | |
| 300 | | | | |
| Aromatic | 33.6 | 33.6 | 33.6 | 33.6 |
| amino | | | | |
| polyether | | | | |
| polyol | | | | |
| Crosslinker | 5 | 5 | 5 | 5 |
| TCPP | 10 | 10 | 10 | 10 |
| Silicone | 1 | 1 | 1 | 1 |
| surfactant | | | | |
| Blow catalyst | 0.7 | 0.7 | 0.7 | 0.7 |
| #1 | | | | |
| Gel catalyst | 2.6 | 2.6 | 2.6 | 2.6 |
| Blow catalyst | 0.3 | 0.3 | 0.3 | 0.3 |
| #2 | | | | |
| Blowing agent | | 3 | | 3 |
| enhancer | | | | |
| containing | | | | |
| glycol ether | | | | |
| Water | 1.8 | 1.8 | 1.8 | 1.8 |
| Z-1336mzz | 10 | 10 | 8 | 8 |
| E-1336mzz | | | 2 | 2 |
| Total | 100 | 100 | 100 | 100 |

Spray foam trials were conducted using the formulations shown in Table 9 above. The formulations were blended in appropriate mixing containers, and allowed to sit for several minutes before being applied in a ventilated test facility onto various sized oriented strand board (OSB) samples via a high-pressure proportioner and spray gun assembly. The foams were applied at 6×½ inch lifts, 3×1 inch lifts, or 2 inches in one lift. The equipment and conditions are described in Example 5 above.

Results of trials are shown in Table 10, below.

TABLE 10
Spray foam trial results

| | | | | Initial k-factor | |
|---|---|---|---|---|---|
| | | Density | Open Cell | (Btu · in/ft² · h · ° F.) | |
| | | (PCF) | (%) | 50° F. | 75° F. |
| Z-1336mzz | 1 inch (2 | 3.04 | 3.16 | 0.1426 | 0.1543 |
| | pass) | | | | |
| | 2 inch (1 | 2.63 | 4.50 | 0.1519 | 0.1626 |
| | pass) | | | | |
| | ½ inch (6 | 3.24 | 4.38 | 0.1433 | 0.1545 |
| | pass) | | | | |
| Z-133mzz | 1 inch (2 | 2.84 | 4.00 | 0.1406 | 0.1519 |
| with BAE | pass) | | | | |
| | 2 inch (1 | 2.73 | 5.40 | 0.1447 | 0.1563 |
| | pass) | | | | |
| | ½ inch (6 | 2.96 | 2.74 | 0.1413 | 0.1524 |
| | pass) | | | | |
| 80:20 Z- | 1 inch (2 | — | — | — | — |
| 1336mzz/E- | pass) | | | | |
| 1336mzz | | | | | |
| | 2 inch (1 | — | — | — | — |
| | pass) | | | | |
| | ½ inch (6 | — | — | — | — |
| | pass) | | | | |
| 80:20 Z- | 1 inch (2 | 3.11 | 5.20 | 0.1463 | 0.1575 |
| 1336mzz/E- | pass) | | | | |
| 1336mzz | | | | | |
| with BAE | | | | | |
| | 2 inch (1 | 2.51 | 32.58 | 0.2127 | 0.2222 |
| | pass) | | | | |
| | ½ inch (6 | 3.41 | 4.71 | 0.1455 | 0.1573 |
| | pass) | | | | |

As can be seen in Table 10, above, the foams that included a blowing agent enhancer that contained glycol ether had a lower density and lower k-factors. In the case of the 80:20 Z-1336mzz/E-1336mzz formulation that did not include any blowing agent enhancer, a foam was unable to be produced.

### Example 7

A series of foams were prepared using the formulations provided in Table 11. The ratios varied of Z-1336mzz and E-1336mzz (100% Z-1336mzz, 80/20 Z-1336mzz/E-1336mzz, 60/40 Z-1336mzz/E-1336mzz, and 40/60 Z-1336mzz/E-1336mzz) and type of blowing agent enhancer (either 3% of a blowing agent enhancer containing glycol ether or 3% of 2.25% butyl cellosolve). A control was also prepared that did not contain any blowing agent. The formulations were pour in place applications.

TABLE 11
Generic Formulation
A Side

| | |
|---|---|
| MDI Polyisocyanate | 100% |

B Side

| | |
|---|---|
| Aromatic Polyester Polyol | 52 pbw |
| Aromatic Amino Polyether Polyol | 48 pbw |
| Blow Catalyst 1 | 1.0 pbw |
| Blow Catalyst 2 | 0.43 pbw |
| Gel Catalyst | 3.70 pbw |
| Silicone surfactant | 1.43 pbw |
| Flame Retardant (TCPP) | 22.7 pbw |
| Water | 3 pbw |
| Opteon ™ Blowing Agent | 20 pbw |

The ratios of Z-1336mzz and E-1336mzz and blowing agent enhancer information are provided in Table 12, below.

TABLE 12
Formulations with and without blowing agent enhancer
Formulations with 3% blowing agent enhancer containing glycol ether

| | |
|---|---|
| 1 | 100% Z-1336mzz |
| 2 | 80% Z-1336mzz/20% E-1336mzz |
| 3 | 60% Z-1336mzz/40% E-1336mzz |
| 4 | 40% Z-1336mzz/60% E-1336mzz |

Formulations with 3% of 2.25% butyl cellosolve

| | |
|---|---|
| 5 | 100% Z-1336mzz |
| 6 | 80% Z-1336mzz/20% E-1336mzz |
| 7 | 60% Z-1336mzz/40% E-1336mzz |
| 8 | 40% Z-1336mzz/60% E-1336mzz |

Controls

| | |
|---|---|
| 9 | 100% Z-1336mzz |
| 10 | 80% Z-1336mzz/20% E-1336mzz |
| 11 | 60% Z-1336mzz/40% E-1336mzz |
| 12 | 40% Z-1336mzz/60% E-1336mzz |

An Ashby Cross GP-80 foam machine with dynamic static mixture was used to make foam samples in 8″×8″×2.5″. The conditions used to make samples are given in Table 13. The samples were cured overnight and cut to 6″×6″×1.5″ and run in heat flow meter (Lasercomp) to determine K-factor at various temperature set points. Blends of Opteon™ 1100/Opteon™ 1150 of 80/20, 70/30 and 60/40 were pre-mixed and used as blowing agents for these samples. Results of trials are shown in Table 14, below.

TABLE 13
GP-80 machine condition

| | |
|---|---|
| Pressures A/B (psig) | 80/80 |
| RPM | 70 |
| Counter | 850 |

TABLE 14
Foam trial results

| | AVG | | | | | |
|---|---|---|---|---|---|---|
| | Open | | Initial k-factor | | 3-month k-factor | |
| Formu- | Cell | Density | (Btu · in/ft² · h · ° F.) | | (Btu · in/ft² · h · ° F.) | |
| lation | (%) | (lbs/ft³) | 75° F. | 20° F. | 75° F. | 20° F. |
| 1 | 93.52 | 2.12 | 0.1350 | 0.1288 | 0.1621 | 0.1619 |
| 2 | 94.23 | 2.16 | 0.1373 | 0.1236 | 0.1623 | 0.1476 |
| 3 | 96.00 | 2.58 | 0.1376 | 0.1221 | 0.1594 | 0.144 |
| 4 | 97.18 | 2.48 | 0.1400 | 0.1219 | 0.1595 | 0.1416 |
| 5 | 93.61 | 2.52 | 0.1380 | 0.1270 | 0.1633 | 0.1537 |
| 6 | 95.29 | 2.64 | 0.1398 | 0.1256 | 0.1639 | 0.149 |
| 7 | 95.47 | 2.49 | 0.1382 | 0.1225 | 0.1602 | 0.1444 |
| 8 | 95.39 | 2.58 | 0.1400 | 0.1216 | 0.1617 | 0.1422 |
| 9 | 95.01 | 2.27 | 0.1374 | 0.1310 | 0.1611 | 0.1598 |
| 10 | 93.80 | 2.41 | 0.1393 | 0.1307 | 0.1626 | 0.1579 |
| 11 | 96.20 | 2.59 | 0.1408 | 0.1259 | 0.1603 | 0.1455 |
| 12 | 94.29 | 2.40 | 0.1397 | 0.1227 | 0.158 | 0.1419 |

As can be seen in Table 14, above, the foams that included a blowing agent enhancer that contained glycol ether or butyl cellosolve had a lower density and lower k-factors. There was consistent improvement in low temperature k-factors as a function of having the additives, with the exception of the 40% Z-1336mzz/60% E-1336mzz, which only showed an initial improvement.

### Example 8

The solubility of E-1336mzz (2.25 wt %) in the polyether polyol Voranol® 360 and various types of glycol ethers was tested as follows. 50 g of the polyol was placed in a pressure capable, oven capable, coated aerosol bottle. E-1336mzz was loaded into a pressure burette and over pressured with nitrogen to 120 psig, then added to the bottle in 1 g increments, with vigorous shaking between additions. The bottle was then allowed to sit until the bubbles dissipated. Solubility was determined by the appearance of a second phase, usually at the bottom of the bottle. In instances where excess E-1336mzz was added, the bottle was vented to obtain a more precise measurement. The results are shown in Table 15, below.

TABLE 15
Solubility of E-1336mzz in a polyether polyol and a glycol ether

| | % Solubility of |
|---|---|
| Glycol + Voranol ® 360 | E-1336mzz |
| E-1336mzz in Voranol ® 360 (control) | 4.0 |
| 40:60 Propylene glycol phenyl ether/propylene glycol | <4.48 |
| methyl ether (Dowanol ™ PPh/PM) | |
| Propylene glycol phenyl ether (Dowanol ™ PPh) | <9.69 |
| Ethylene glycol phenyl ether (Dowanol ™ EpH) | 8.66 |
| Propylene glycol methyl ether (Dowanol ™ PM) | <6.88 |
| 50:25:25 Propylene glycol n-propyl ether/propylene | <11.32 |
| glycol n-butyl ether/dipropylene glycol methyl ether | |
| (Dowanol ™ PnP/PnB/DPM) | |
| Diethylene glycol monohexyl ether (Hexyl Carbitol ™) | <13.35 |
| Butyl cellosolve (2-butoxyethanol) | 13.0 |

As shown in Table 15, above, the solubility of E-1336mzz in the polyether polyol improved upon addition of one or more glycol ethers. Butyl cellosolve increased the solubility of E-1336mzz to 13.0%. A series of formulations containing 2.25 wt % E-1336mzz in the polyether polyol Voranol® 360 were then prepared with varying amounts of butyl cellosolve. The solubility was tested as described above. The results are shown in Table 16, below.

TABLE 16
Solubility of E-1336mzz in a polyether polyol with varying
amounts of butyl cellosolve

| Wt % butyl cellosolve (2-butoxyethanol) | % Solubility of E-1336mzz |
|---|---|
| E-1336mzz in Voranol ® 360 (control) | 4.0 |
| 0.75% | 4.20 |
| 1% | <4.0 |
| 1.5% | 4.96 |
| 2% | ~8.8 |
| 2.25% | 13.34 |
| 3% | ~13.0 |

Table 16 shows that the solubility of E-1336mzz in the polyether polyol increased with increasing amounts of butyl cellosolve, with a maximum solubility in the formulations tested at about 2.25 wt % butyl cellosolve.

### Example 9

Spray Foam Performance (SPF)

A generic SPF formulation was tested in which a control Opteon™ 1100 recipe was compared to a 70:30 Opteon™ 1100/Opteon™ 1150 blend as provided in Table 17. The application parameters are listed in Table 18.

TABLE 17
Generic SPF Formulation

| Components | Wt % |
|---|---|
| Opteon ™ 1100 | 10 |
| Solubility Enhancer | 3 |
| Polyester polyol OH# 300 | 332 |
| Aromatic amino polyether | 33.6 |
| polyol | |
| Cross linker | 5 |
| TCPP | 10 |
| Silicone surfactant | 1 |
| Blow catalyst #1 | 0.7 |
| Gel catalyst | 2.6 |
| Blow catalyst #2 | 0.3 |
| Water | 1.8 |
| Total | 100 |

TABLE 18
Spray Foam Application Parameters

| Equipment | | | | |
|---|---|---|---|---|
| Proportioner | Graco E-10 | | | |
| Spray gun | Fusion AR4242 | | | |
| Hoses | 60 | ft | 18.3 | m |
| Processing conditions | | | | |
| Temperature (A &B) - | 140° | F. | 60° | C. |
| Opteon ™ 1100 | | | | |
| Temperature (A &B) - | 120° | F. | 48.9° | C. |
| 70:30 Opteon ™ 1100/ | | | | |
| 1150 Blend | | | | |
| Pressure (A & B) | 1000 | psi | 68.9 | bar |
| Ambient temperature | 85° | F. | 29.4° | C. |

| | |
|---|---|
| Humidity | 75% |
| Application Details | |
| # Lifts/Thickness | 1 Lift by 3 inches, 1 Lift by 4 inches, |
| | 6 Lifts by ½ inches |

Note, in order to match the reactivity profiles of the two systems, the application temperature was set to 140° F. (HT) for the Opteon™ 1100 system versus 120° F. (LT) for the 70:30 Opteon™ 1100/1150 blend. These conditions provided the most reproducible and optimized performance for the generic system at this blowing agent loading level.

The foam formulations were successfully applied to 2′×2′ OSB panels per the specified number of lifts and thicknesses. No problems were encountered with spraying, gun blockage, or application behavior. In fact, the Opteon™ 70:30 blend appeared to lay down more easily and with a more rapid rise. After 24 hours, the foams were cut into 6×6×1 inch samples, conditioned for 24 h at 50% R.H., before analysis. The performance data is summarized in Table 19.

TABLE 19
Performance Details

| | | | Initial k-Factor | |
|---|---|---|---|---|
| | | | (Btu in/ft²h ° F.)) | |
| | | | Thermal | Thermal |
| | Density | Closed | Performance | Performance |
| | (PCF) | Cell % | 75° F. | 20° F. |
| Opteon ™ 1100/1150 | 2.06 | 85.25 | 0.1539 | 0.1285 |
| LT 3″ | | | | |
| 1100/1150 LT 4″ | 1.93 | 89.58 | 0.1544 | 0.1293 |
| 1100/1150 LT ½″ × 6 | 2.44 | 95.49 | 0.1565 | 0.1319 |
| 1100 HT 3″ | 2.31 | 80.39 | 0.1683 | 0.1446 |
| 1100 HT 4″ | 2.05 | 82.98 | 0.1854 | 0.16 |
| 1100 HT ½″ × 6 | 2.95 | 94.48 | 0.1638 | 0.1417 |

As was observed in the previous study, a significant reduction in low temperature k-factor performance was measured at all pass thickness applications.

### Other Embodiments

1. In some embodiments, the present application provides a composition, comprising:

i) a hydrofluoroolefin blowing agent having the formula Z—CF₃CH═CHCF₃ or E-CF₃CH═CHCF₃ or a mixture thereof;

ii) a polyol blend comprising polyester polyols and polyether polyols; and

iii) a blowing agent enhancer.

2. The composition of embodiment 1, wherein the blowing agent comprises between about 5% and about 30% by weight of the composition.
3. The composition of embodiment 1, wherein the blowing agent comprises between about 8% and about 25% by weight of the composition.
4. The composition of embodiment 1, wherein the blowing agent comprises between about 8% and about 10% by weight of the composition.
5. The composition of any one of embodiments 1 to 4, wherein the blowing agent is Z—CF₃CH═CHCF₃.
6. The composition of any one of embodiments 1 to 4, wherein the blowing agent is E-CF₃CH═CHCF₃.
7. The composition of any one of embodiments 1 to 4, wherein the blowing agent is a mixture of Z—CF₃CH═CHCF₃ and E-CF₃CH═CHCF₃.
8. The composition of embodiment 7, wherein the Z—CF₃CH═CHCF₃ and E-CF₃CH═CHCF₃ are present in a weight ratio of about 10:1 to about 1:10 Z—CF₃CH═CHCF₃ to E-CF₃CH═CHCF₃.
9. The composition of embodiment 7, wherein the Z—CF₃CH═CHCF₃ and E-CF₃CH═CHCF₃ are present in a weight ratio of about 4:1 Z—CF₃CH═CHCF₃ to E-CF₃CH═CHCF₃, 3:2 Z—CF₃CH═CHCF₃ to E-CF₃CH═CHCF₃, or about 2:3 Z—CF₃CH═CHCF₃ to E-CF₃CH═CHCF₃, or about 4:1 Z—CF₃CH═CHCF₃ to E-CF₃CH═CHCF₃.
10. The composition of any one of embodiments 1 to 9, wherein the polyol blend comprises a weight ratio of about 1:1 to about 2:1 polyester polyols to polyether polyols.
11. The composition of any one of embodiments 1 to 9, wherein the polyol blend comprises a 1:1 weight ratio of polyester polyols to polyether polyols.
12. The composition of any one of embodiments 1 to 9, wherein the polyol blend comprises a 1.9:1 weight ratio of polyester polyols to polyether polyols.
13. The composition of any one of embodiments 1 to 12, wherein the blowing agent enhancer is a triol.
14. The composition of any one of embodiments 1 to 12, wherein the blowing agent enhancer is an oxypropylated polyether triol.
15. The composition of embodiment 13 or 14, wherein the triol has an average molecular weight of from about 800 to about 1200 g/mol.
16. The composition of embodiment 13 or 14, wherein the triol has an average molecular weight of from about 800 to about 1200 g/mol.
17. The composition of any one of embodiments 13 to 16, wherein the triol has an average hydroxyl number of from about 150 to about 200 mg KOH/gram.
18. The composition of any one of embodiments 13 to 17, wherein greater than about 95% of the hydroxyl groups on the triol are secondary hydroxyl groups.
19. The composition of any one of embodiments 1 to 12, wherein the blowing agent enhancer comprises one or more glycol ethers selected from the group consisting of 2-methoxyethanol, 2-ethoxyethanol, 2-propoxyethanol, 2-isopropoxyethanol, 2-butoxyethanol (butyl cellosolve), 2-phenoxyethanol, 2-benzyloxyethanol, 2-(2-methoxyethoxy)ethanol (methyl carbitol), 2-(2-ethoxyethoxy)ethanol (carbitol cellosolve), 2-(2-butoxyethoxy)ethanol (butyl carbitol), propylene glycol phenyl ether, propylene glycol methyl ether (1-methoxy-2-propanol), ethylene glycol phenyl ether, propylene glycol n-propyl ether, propylene glycol n-butyl ether (3-butoxypropan-2-ol), dipropylene glycol methyl ether, and hexyl carbitol.
20. The composition of embodiment 19, wherein the glycol ether comprises 2-butoxyethanol.
21. The composition of any one of embodiments 1 to 20, wherein the blowing agent enhancer further comprises a surfactant.
22. The composition of embodiment 21, wherein the surfactant is selected from the group consisting of a liquid or solid organosilicone compound, a polyethylene glycol ether of a long chain alcohol, a tertiary amine or alkanolamine salt of a long chain alkyl acid sulfate ester, an alkyl sulfonic ester, and an alkyl arylsulfonic acid.
23. The composition of any one of embodiments 1 to 12 and 19 to 22, wherein the blowing agent enhancer comprises about 60% to about 95% 2-butoxyethanol and about 5% about 40% surfactant.
24. The composition of any one of embodiments 1 to 23, wherein the blowing agent enhancer comprises about 0.5% to about 5% by weight of the composition.
25. The composition of embodiment 1, comprising:

a hydrofluoroolefin blowing agent that has the formula E-CF₃CH═CHCF₃;

a polyol blend comprising polyester polyols and polyether polyols; and

a blowing agent enhancer that is a triol.

26. The composition of embodiment 25, comprising:

a hydrofluoroolefin blowing agent that has the formula E-CF₃CH═CHCF₃;

a polyol blend comprising polyester polyols and polyether polyols; and

a blowing agent enhancer that is an oxypropylated polyether triol.

27. The composition of embodiment 1, comprising:

a hydrofluoroolefin blowing agent that has the formula E-CF₃CH═CHCF₃;

a polyol blend comprising polyester polyols and polyether polyols; and

a blowing agent enhancer comprising 2-butoxyethanol.

28. The composition of embodiment 1, comprising:

a hydrofluoroolefin blowing agent that is a mixture of Z—CF₃CH═CHCF₃ and E-CF₃CH═CHCF₃;

a polyol blend comprising polyester polyols and polyether polyols; and

a blowing agent enhancer comprising 2-butoxyethanol.

29. The composition of embodiment 25, comprising:

a hydrofluoroolefin blowing agent comprising E-CF₃CH═CHCF₃, wherein the hydrofluoroolefin blowing agent comprises between about 8% and about 10% by weight of the composition;

a polyol blend comprising a 1:1 weight ratio of polyester polyols to polyether polyols; and

a blowing agent enhancer comprising a triol that is an oxypropylated polyether triol with an average molecular weight of about 1000 g/mol and an average hydroxyl number of from about 165 to about 175 mg KOH/gram.

30. The composition of embodiment 1, comprising:

a hydrofluoroolefin blowing agent comprising E-CF₃CH═CHCF₃, wherein the hydrofluoroolefin blowing agent comprises between about 8% and about 10% by weight of the composition;

a polyol blend comprising a 1:1 weight ratio of polyester polyols to polyether polyols; and

a blowing agent enhancer comprising about 70% to about 80% 2-butoxyethanol and about 20% to about 30% of a surfactant, wherein the blowing agent enhancer comprises between about 0.5% to about 5% by weight of the composition.

31. The composition of embodiment 1, comprising:

a hydrofluoroolefin blowing agent that is a mixture of Z—CF₃CH═CHCF₃ and E-CF₃CH═CHCF₃ present in a weight ratio of about 4:1 Z—CF₃CH═CHCF₃ to E-CF₃CH═CHCF₃;

a polyol blend comprising a weight ratio of about 1:1 to about 2:1 polyester polyols to polyether polyols; and

a blowing agent enhancer comprising one or more glycol ethers, wherein the blowing agent enhancer comprises between about 0.5% to about 5% by weight of the composition.

32. The composition of embodiment 1, wherein the composition further comprises one or more additives selected from the group consisting of a catalyst, a surfactant, and a flame retardant.
33. The composition of embodiment 1, wherein the blowing agent remains soluble in the composition without separating from the polyol blend for at least 6 months.
34. The composition of embodiment 1, comprising:

a hydrofluoroolefin blowing agent that is a mixture of Z—CF₃CH═CHCF₃ and E-CF₃CH═CHCF₃ present in a weight ratio of about 4:1 Z—CF₃CH═CHCF₃ to E-CF₃CH═CHCF₃, wherein the hydrofluoroolefin blowing agent comprises between about 8% to about 10% by weight of the composition;

a polyol blend comprising a weight ratio of about 1.9:1 polyester polyols to polyether polyols, wherein the polyol blend comprises between about 65% to about 75% by weight of the composition; and

a blowing agent enhancer comprising one or more glycol ethers, wherein the blowing agent enhancer comprises about 3% by weight of the composition.

35. The composition of embodiment 1, wherein the composition is a foamable composition.
36. In some embodiments, the present application provides a spray polyurethane foam, comprising the composition of any one of embodiments 1 to 35.
37. The foam of embodiment 36, wherein the composition comprises:

a hydrofluoroolefin blowing agent that has the formula E-CF₃CH═CHCF₃, wherein the hydrofluoroolefin blowing agent comprises between about 8% and about 10% by weight of the composition;

a polyol blend comprising a 1:1 weight ratio of polyester polyols to polyether polyols; and

a blowing agent enhancer comprising a triol that is an oxypropylated polyether triol with an average molecular weight of about 1000 g/mol and an average hydroxyl number of from about 165 to about 175 mg KOH/gram.

38. The foam of embodiment 36, wherein the composition comprises:

a hydrofluoroolefin blowing agent that has the formula E-CF₃CH═CHCF₃, wherein the hydrofluoroolefin blowing agent comprises between about 8% and about 10% by weight of the composition;

a polyol blend comprising a 1:1 weight ratio of polyester polyols to polyether polyols; and

a blowing agent enhancer comprising about 70% to about 80% 2-butoxyethanol and about 20% to about 30% of a surfactant, wherein the blowing agent enhancer comprises between about 0.5% to about 5% by weight of the composition.

39. The foam of embodiment 36, wherein the composition comprises:

a hydrofluoroolefin blowing agent that is a mixture of Z—CF₃CH═CHCF₃ and E-CF₃CH═CHCF₃ present in a weight ratio of about 4:1 Z—CF₃CH═CHCF₃ to E-CF₃CH═CHCF₃;

a polyol blend comprising a weight ratio of about 1:1 to about 2:1 polyester polyols to polyether polyols; and

a blowing agent enhancer comprising one or more glycol ethers, wherein the blowing agent enhancer comprises between about 0.5% to about 5% by weight of the composition.

40. The foam of any one of embodiments 36 to 39, wherein the k-factor after one month of aging at 50° F. is about 0.19 Btu·in/ft²·h·° F. or less.
41. The foam of any one of embodiments 36 to 39, wherein the k-factor after one month of aging at 50° F. is about 0.17 Btu·in/ft²·h·° F. or less.
42. The foam of any one of embodiments 36 to 39, wherein the k-factor after one month of aging at 50° F. is about 0.16 Btu·in/ft²·h·° F. or less.
43. The foam of any one of embodiments 36 to 39, wherein the k-factor after one month of aging at 75° F. is about 0.2 Btu·in/ft²·h·° F. or less.
44. The foam of any one of embodiments 36 to 39, wherein the k-factor after one month of aging at 75° F. is about 0.19 Btu·in/ft²·h·° F. or less.
45. The foam of any one of embodiments 36 to 39, wherein the k-factor after one month of aging at 75° F. is about 0.18 Btu·in/ft²·h·° F. or less.
46. The foam of any one of embodiments 36 to 39, wherein the k-factor after one month of aging at 75° F. is about 0.17 Btu·in/ft²·h·° F. or less.
47. The foam of any one of embodiments 36 to 46, wherein the foam has a density of from about 2.5 to about 3.5 g/cm³.
48. In some embodiments, the present application provides a method of forming a foam, comprising reacting or extruding a composition of any one of embodiments 1 to 35 under conditions effective to form a foam.
49. The method of embodiment 48, wherein the composition comprises:

a hydrofluoroolefin blowing agent that has the formula E-CF₃CH═CHCF₃, wherein the hydrofluoroolefin blowing agent comprises between about 8% and about 10% by weight of the composition;

a polyol blend comprising a 1:1 weight ratio of polyester polyols to polyether polyols; and

a blowing agent enhancer comprising a triol that is an oxypropylated polyether triol with an average molecular weight of about 1000 g/mol and an average hydroxyl number of from about 165 to about 175 mg KOH/gram.

50. The method of embodiment 48, wherein the composition comprises:

a hydrofluoroolefin blowing agent that has the formula E-CF₃CH═CHCF₃, wherein the hydrofluoroolefin blowing agent comprises between about 8% and about 10% by weight of the composition;

a polyol blend comprising a 1:1 weight ratio of polyester polyols to polyether polyols; and

a blowing agent enhancer comprising about 70% to about 80% 2-butoxyethanol and about 20% to about 30% of a surfactant between, wherein the blowing agent enhancer comprises about 0.5% to about 5% by weight of the composition.

51. The method of embodiment 48, wherein the composition comprises:

a hydrofluoroolefin blowing agent that is a mixture of Z—CF₃CH═CHCF₃ and E-CF₃CH═CHCF₃ present in a weight ratio of about 4:1 Z—CF₃CH═CHCF₃ to E-CF₃CH═CHCF₃;

a polyol blend comprising a weight ratio of about 1:1 to about 2:1 polyester polyols to polyether polyols; and

a blowing agent enhancer comprising one or more glycol ethers, wherein the blowing agent enhancer comprises between about 0.5% to about 5% by weight of the composition.

52. The method of embodiment 48, wherein the composition comprises:

a hydrofluoroolefin blowing agent that is a mixture of Z—CF₃CH═CHCF₃ and E-CF₃CH═CHCF₃ present in a weight ratio of about 4:1 Z—CF₃CH═CHCF₃ to E-CF₃CH═CHCF₃, wherein the hydrofluoroolefin blowing agent comprises between about 8% to about 10% by weight of the composition;

a polyol blend comprising a weight ratio of about 1.9:1 polyester polyols to polyether polyols, wherein the polyol blend comprises between about 65% to about 75% by weight of the composition; and

a blowing agent enhancer comprising one or more glycol ethers, wherein the blowing agent enhancer comprises about 3% by weight of the composition.

53. The method of embodiment 48, wherein the foam is a closed cell foam.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

1. A composition, comprising:
i) a hydrofluoroolefin blowing agent having the formula Z—CF₃CH═CHCF₃ or E-CF₃CH═CHCF₃ or a mixture thereof;
ii) a polyol blend comprising polyester polyols and polyether polyols; and
iii) a blowing agent enhancer.

2. The composition of claim 1, wherein the blowing agent comprises between about 5% and about 30% by weight of the composition.

3-4. (canceled)

5. The composition of claim 1, wherein the blowing agent is Z—CF₃CH═CHCF₃ or E-CF₃CH═CHCF₃.

6. (canceled)

7. The composition of claim 1, wherein the blowing agent is a mixture of Z—CF₃CH═CHCF₃ and E-CF₃CH═CHCF₃.

8. The composition of claim 7, wherein the Z—CF₃CH═CHCF₃ and E-CF₃CH═CHCF₃ are present in a weight ratio of about 10:1 to about 1:10 Z—CF₃CH═CHCF₃ to E-CF₃CH═CHCF₃.

9. (canceled)

10. The composition of claim 1, wherein the polyol blend comprises a weight ratio of about 1:1 to about 2:1 polyester polyols to polyether polyols.

11-12. (canceled)

13. The composition of claim 1, wherein the blowing agent enhancer is a triol.

14. The composition of claim 1, wherein the blowing agent enhancer is an oxypropylated polyether triol.

15-17. (canceled)

18. The composition of claim 1, wherein the blowing agent enhancer comprises one or more glycol ethers selected from the group consisting of 2-methoxyethanol, 2-ethoxyethanol, 2-propoxyethanol, 2-isopropoxyethanol, 2-butoxyethanol (butyl cellosolve), 2-phenoxyethanol, 2-benzyloxyethanol, 2-(2-methoxyethoxy)ethanol (methyl carbitol), 2-(2-ethoxyethoxy)ethanol (carbitol cellosolve), 2-(2-butoxyethoxy)ethanol (butyl carbitol), propylene glycol phenyl ether, propylene glycol methyl ether (1-methoxy-2-propanol), ethylene glycol phenyl ether, propylene glycol n-propyl ether, propylene glycol n-butyl ether (3-butoxypropan-2-ol), dipropylene glycol methyl ether, and hexyl carbitol.

19. (canceled)

20. The composition of claim 1, wherein the blowing agent enhancer further comprises a surfactant.

21. The composition of claim 20, wherein the surfactant is selected from the group consisting of a liquid or solid organosilicone compound, a polyethylene glycol ether of a long chain alcohol, a tertiary amine or alkanolamine salt of a long chain alkyl acid sulfate ester, an alkyl sulfonic ester, and an alkyl arylsulfonic acid.

22. The composition of claim 18, wherein the blowing agent enhancer comprises about 60% to about 95% 2-butoxyethanol and about 5% about 40% surfactant.

23. (canceled)

24. The composition of claim 1, comprising:
a hydrofluoroolefin blowing agent that has the formula E-CF₃CH═CHCF₃;
a polyol blend comprising polyester polyols and polyether polyols; and
a blowing agent enhancer that is a triol.

25-26. (canceled)

27. The composition of claim 1, comprising:
a hydrofluoroolefin blowing agent that is a mixture of Z—CF₃CH═CHCF₃ and E-CF₃CH═CHCF₃;
a polyol blend comprising polyester polyols and polyether polyols; and
a blowing agent enhancer comprising 2-butoxyethanol.

28. The composition of claim 1, comprising:
a hydrofluoroolefin blowing agent comprising E-CF₃CH═CHCF₃, wherein the hydrofluoroolefin blowing agent comprises between about 8% and about 10% by weight of the composition;
a polyol blend comprising a 1:1 weight ratio of polyester polyols to polyether polyols; and
a blowing agent enhancer comprising a triol that is an oxypropylated polyether triol with an average molecular weight of about 1000 g/mol and an average hydroxyl number of from about 165 to about 175 mg KOH/gram.

29. The composition of claim 1, comprising:
a hydrofluoroolefin blowing agent comprising E-CF₃CH═CHCF₃, wherein the hydrofluoroolefin blowing agent comprises between about 8% and about 10% by weight of the composition;
a polyol blend comprising a 1:1 weight ratio of polyester polyols to polyether polyols; and
a blowing agent enhancer comprising about 70% to about 80% 2-butoxyethanol and about 20% to about 30% of a surfactant, wherein the blowing agent enhancer comprises between about 0.5% to about 5% by weight of the composition.

30. The composition of claim 1, comprising:
a hydrofluoroolefin blowing agent that is a mixture of Z—CF₃CH═CHCF₃ and E-CF₃CH═CHCF₃ present in a weight ratio of about 4:1 Z—CF₃CH═CHCF₃ to E-CF₃CH═CHCF₃;
a polyol blend comprising a weight ratio of about 1:1 to about 2:1 polyester polyols to polyether polyols; and
a blowing agent enhancer comprising one or more glycol ethers, wherein the blowing agent enhancer comprises between about 0.5% to about 5% by weight of the composition.

31. The composition of claim 1, wherein the composition further comprises one or more additives selected from the group consisting of a catalyst, a surfactant, and a flame retardant.

32. (canceled)

33. The composition of claim 1, comprising:
a hydrofluoroolefin blowing agent that is a mixture of Z—CF₃CH═CHCF₃ and E-CF₃CH═CHCF₃ present in a weight ratio of about 4:1 Z—CF₃CH═CHCF₃ to E-CF₃CH═CHCF₃, wherein the hydrofluoroolefin blowing agent comprises between about 8% to about 10% by weight of the composition;
a polyol blend comprising a weight ratio of about 1.9:1 polyester polyols to polyether polyols, wherein the polyol blend comprises between about 65% to about 75% by weight of the composition; and
a blowing agent enhancer comprising one or more glycol ethers, wherein the blowing agent enhancer comprises about 3% by weight of the composition.

34. The composition of claim 1, wherein the composition is a foamable composition.

35. A spray polyurethane foam, comprising the composition of claim 1.

36-38. (canceled)

39. The foam of claim 35, wherein the k-factor after one month of aging at 50° F. is about 0.19 Btu·in/ft²·h·° F. or less.

40-41. (canceled)

42. The foam of claim 35, wherein the k-factor after one month of aging at 75° F. is about 0.2 Btu·in/ft²·h·° F. or less.

43-45. (canceled)

46. The foam of claim 35, wherein the foam has a density of from about 2.5 to about 3.5 g/cm³.

47. A method of forming a foam, comprising reacting or extruding a composition of claim 1 under conditions effective to form a foam.

48-51. (canceled)

52. The method of claim 47, wherein the foam is a closed cell foam.
